(19) United States
(12) Patent Application Publication
(10) Pub. No.: US 2016/0320792 A1
(43) Pub. Date: Nov. 3, 2016

(54) OPERATION PEDAL FOR VEHICLE

(71) Applicant: TOYODA IRON WORKS CO., LTD., Toyota-shi (JP)

(72) Inventor: Kozo RYUTAKI, Okazaki-shi (JP)

(73) Assignee: TOYODA IRON WORKS CO., LTD., Toyota-shi (JP)

(21) Appl. No.: 15/210,129

(22) Filed: Jul. 14, 2016

Related U.S. Application Data
(63) Continuation of application No. PCT/JP2014/064533, filed on May 30, 2014.

(30) Foreign Application Priority Data
Jan. 22, 2014 (JP) 2014-009301

(51) Int. Cl. G05G 1/44

(52) U.S. Cl. CPC G05G 1/44

(57) ABSTRACT

A reinforcement rib is provided from surroundings of a boss section continuously extending towards a lower-end portion thereof, and the boss section is provided substantially perpendicular to a flat section of the reinforcement rib; this improves the strength of the pedal arm as appropriate including the surroundings of the boss section on which a large load is applied at the time of depressing operation, and thus makes it possible to achieve reduction in weight and costs by thickness reduction while securing a required strength. Although the pedal arm is of a flat plate shape, providing a front side flange and a rear side flange allows for forming a front side recess and a rear side recess between the reinforcement rib and the respective front side flange and rear side flange.

### CROSS-REFERENCE TO RELATED APPLICATION

This application is based upon and claims the benefit of priority of the prior Japanese Patent Application No. 2014-009301, filed on Jan. 22, 2014, the entire contents of which are incorporated herein by reference.

### FIELD

The present application pertains to an operation pedal for vehicles, and in particular, relates to an improvement in an operation pedal for vehicles in which a reinforcement rib is provided in a plate-shaped pedal arm.

1. Background

There is known an operation pedal for vehicles, which has a plate-shaped pedal arm supported pivotally about a substantially horizontal support shaft line via a hollow cylindrically-shaped boss section and which pedal arm is provided with a reinforcement rib that expands in a plate thickness direction, which operation pedal for vehicles is operated by a driver by the driver depressing a tread section provided on a lower end section of the pedal arm. One example of this is the operation pedal for vehicles described in Patent Document 1, whose transverse plane forms a U-shape, whose boss section is provided for each of a pair of side plates, and whose linear reinforcement rib is provided along a longitudinal direction at a part separated downwards from the boss section.

2. Related Art

### Patent Document

Patent Document 1: Japanese Laid-open Patent Publication No. 2013-69031

### SUMMARY

However, in the conventional operation pedal for vehicles in which a reinforcement rib is provided in a part separated from the boss section as such, no reinforcement is made for surroundings of the boss section on which a large load is applied at a time of the depressing operation. Accordingly, there are cases in which the strength is partially insufficient when attempting to reduce the thickness and weight thereof, and thus could not be sufficiently reduced in weight.

The present application is accomplished in view of the above situation, and an object thereof is to minimize an unevenness in reinforcement by a reinforcement rib in an operation pedal for vehicles whose pedal arm is provided with the reinforcement rib, and allow for attempting further reduction in thickness and weight.

In order to attain the above object, a first aspect is characterized in that an operation pedal for vehicles comprises a plate-shaped pedal arm supported pivotally about a substantially horizontal support shaft line via a cylindrically-shaped boss section, the pedal arm includes a reinforcement rib provided expanding in a plate thickness direction and a tread section provided in a lower-end portion of the pedal arm to be depressing operated by a driver, wherein (a) the reinforcement rib is provided including surroundings of the boss section and extending continuously from the surroundings of the boss section towards the lower-end portion of the pedal arm, and (b) the boss section is provided perpendicularly to a flat section constituting a top part of the reinforcement rib.

And the pedal arm is of a flat plate shape, that includes a front side flange provided on an outer peripheral edge portion of a front side of the vehicle and a rear side flange provided on an outer peripheral edge portion of a rear side of the vehicle, the front side flange and rear side flange each protruding in identical directions to an expanding direction of the reinforcement rib, and the pedal arm includes a recess formed between the front side flange and the reinforcement rib and between the rear side flange and the reinforcement rib.

The object and advantages of the invention will be realized and attained by means of the elements and combinations particularly pointed out in the claims.

It is to be understood that both the forgoing general description and the following detailed description are exemplary and explanatory and are not restrictive of the invention.

### BRIEF DESCRIPTION OF DRAWINGS

FIG. 1 is a left side view illustrating a parking brake pedal for vehicles, being one embodiment of the present application.

FIG. 2 is an enlarged sectional view of a part seen in the arrow direction of II-II in FIG. 1, that is to say, a part where a boss section of the parking brake pedal is provided.

FIG. 3 is an enlarged sectional view of a part seen in the arrow direction of III-III in FIG. 1, that is to say, an intermediate part in a longitudinal direction of a pedal arm of the parking brake pedal.

FIG. 4 is a perspective view of a pedal arm of the parking brake pedal in FIG. 1.

FIG. 5A-5C are a view describing one example of a manufacturing process of the pedal arm in FIG. 4.

### DESCRIPTION OF THE EMBODIMENTS

The present application is suitably applicable to a parking brake pedal and service brake pedal that require a relatively high strength, however may also be applied to other operating pedals for vehicles such as an accelerator pedal. The boss section is provided integrally to the pedal arm by for example a burring process, however a hollow cylindrically-shaped boss constructed separately may be fixedly installed to the pedal arm integrally by using a fixedly installing means such as welding. The plate-shaped pedal arm is constituted of for example a simple flat-plate-shaped metal plate material, however it is also possible to employ a pedal arm as described in Patent Document 1 that is bent in a U-shape and which has a pair of side plates. Moreover, the present application is also applicable to a pedal arm partially or entirely made of synthetic resin, not limited to the metal plate material.

A reinforcement rib is continuously provided from surroundings of the boss section extending towards a lower-end portion, and its range is determined as appropriate in accordance with the shape and like aspects of the pedal arm, in order to achieve a predetermined strength throughout the entire pedal arm. For example, it is preferable to provide the reinforcement rib in a region of 50% or more of a region from the surroundings of the boss section to the lower-end portion (range excluding a part in which the reinforcement rib cannot be provided continuously, such as a part of an attachment section for attaching a tread section), and may be provided to substantially the entire range (for example 80% or more) depending on the shape of the pedal arm.

And although the front side flange and the rear side flange are provided to a flat-plate-shaped pedal arm, these flanges may be omitted in implementing other aspects. Moreover, in the second aspect and the third aspect, although the arc-shaped rib is provided in the upper-end portion of the pedal arm, in implementing other aspects, this arc-shaped rib may be omitted, or a flange bent at substantially right angles to a peripheral edge of the upper-end portion may be provided instead of the arc-shaped rib.

In the fourth aspect, the reinforcement rib is formed upon bulging, and the boss section is provided by a burring process; for example, the boss section can be molded with high dimensional accuracy by carrying out the burring process after the bulging formation process. However, the burring process may be carried out before carrying out the bulging formation process. In the fifth aspect, although the boss section is provided in a manner protruding just in a direction opposite to the expanding direction of the reinforcement rib, when implementing other aspects, it is also possible to provide the boss section in such a manner that the boss section further protrudes in a direction identical to the expanding direction of the reinforcement rib. In a case in which the boss section is fixedly installed to the pedal arm by welding or like process, it is possible to provide the boss section so as to protrude out from both sides of the flat section.

### EXAMPLES

The following describes in details of an Example of the present application, with reference to the drawings.

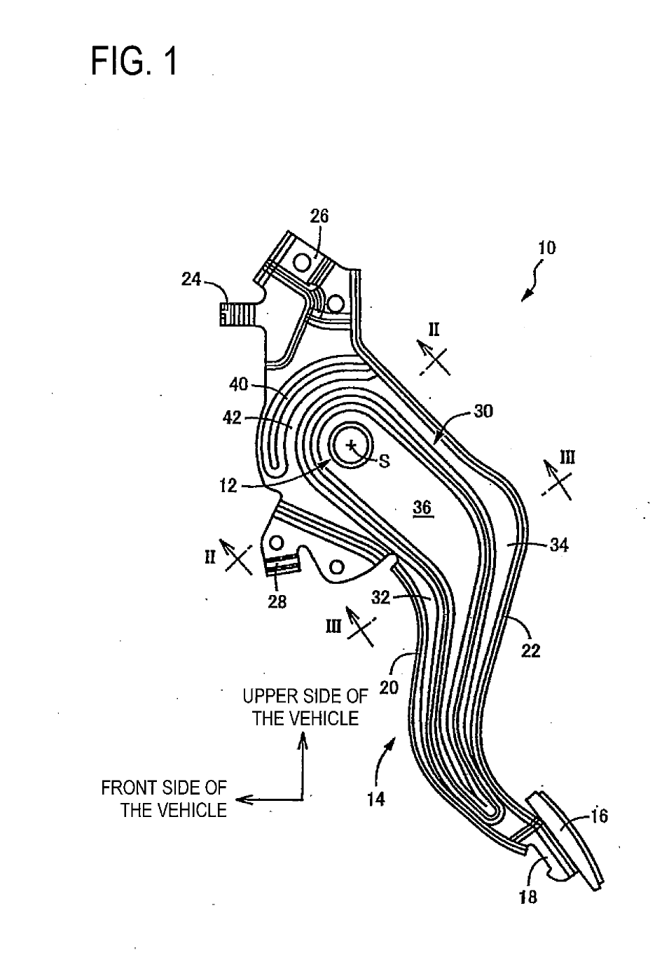

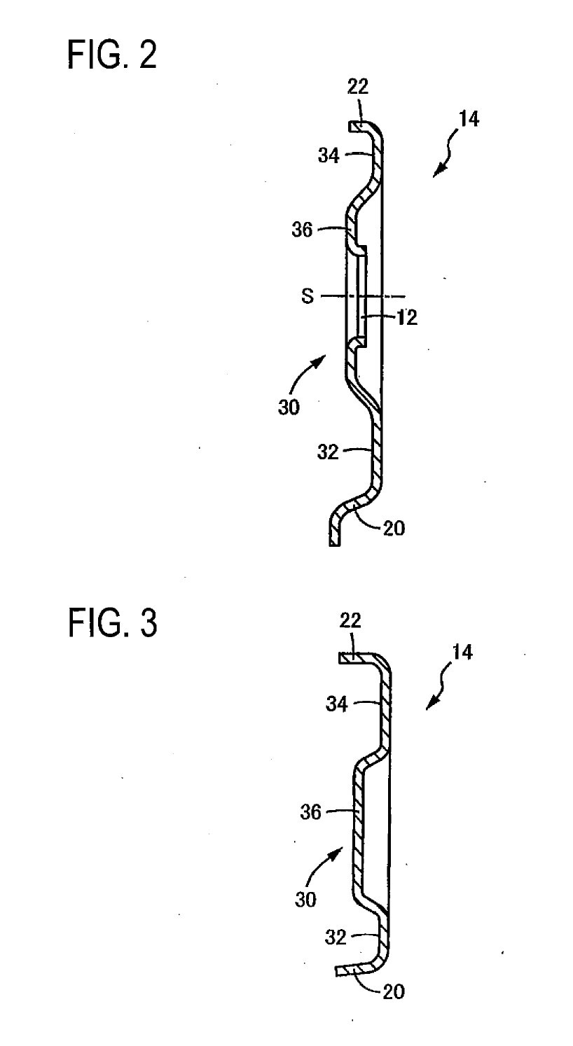

FIG. 1 is a left side view illustrating a parking brake pedal 10 for vehicles to which the present application is applied, and FIG. 2 and FIG. 3 are enlarged sectional views of parts II-II and III-III in FIG. 1, respectively, each seen in the directions illustrated by the arrows. This parking brake pedal 10 includes a plate-shaped pedal arm 14 supported pivotally about a substantially horizontal support shaft line S via a hollow cylindrically-shaped boss section 12, and a tread section 16 such as a pedal sheet is attached to a lower-end portion of the pedal arm 14. On the lower-end portion of the pedal arm 14, an attachment section 18 is integrally provided for attaching the tread section 16. When the tread section 16 is depressing operated by the driver, the parking brake pedal 10 is pivoted about the support shaft line S in a clockwise direction in FIG. 1 thereby tightening a parking brake cable not illustrated to mechanically activate a parking brake provided on the wheels, return pivoting is blocked by a locking mechanism such as a ratchet, and the activated state of the parking brake is maintained. In the present example, the parking brake pedal 10 corresponds to the operation pedal for vehicles.

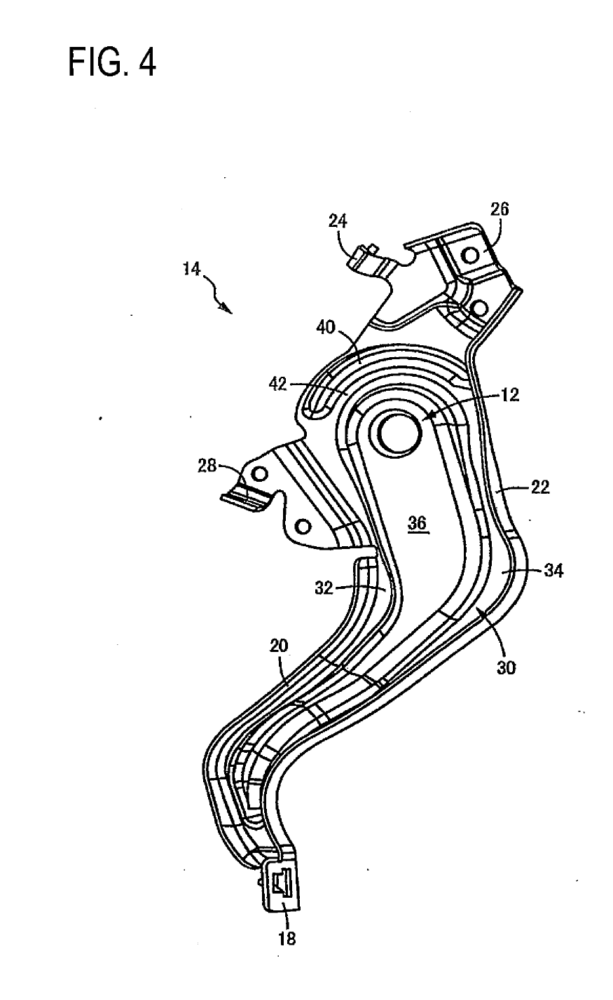

FIG. 4 is a perspective view illustrating the pedal arm 14 alone, that is to say, a perspective view of a state prior to attachment of the tread section 16. This pedal arm 14 gradually narrows in its width dimension in the vehicle front-rear direction as the pedal arm 14 extends from the upper-end portion in which the boss section 12 is provided, toward the lower-end portion where the tread section 16 is provided, and is bent to be in a substantially reverse-S shape in the left side view of FIG. 1. Moreover, the pedal arm 14 is made up of one piece of flat-plate-shaped metal plate material positioned substantially upright as illustrated in FIG. 2 and FIG. 3 in a state installed in a vehicle, and a front side flange 20 and a rear side flange 22 are provided on a peripheral edge portion of the front side of the vehicle and a peripheral edge portion of the rear side of the vehicle, respectively, which each front side flange 20 and rear side flange 22 is bent at substantially right angles toward the same side in the plate thickness direction (left side in FIG. 2 and FIG. 3). Integrally formed on the upper-end part of the pedal arm 14 is, for example, a hook section 24 for hooking a return spring, and a cable coupling section 26 to which the parking brake cable is coupled, and provided integrally on an upper end part of the front side flange 20 is, for example, a switch attachment seat 28 for attaching a brake switch. These front side flange 20, rear side flange 22, hook section 24, cable coupling section 26, switch attachment seat 28, and attachment section 18 are formed for example by bend processing due to press working.

The pedal ann 14 has a reinforcement rib 30 provided throughout the substantially entire region thereof including the surroundings of the boss section 12 up to its lower-end portion, along a longitudinal direction of the pedal ann 14. In the present Example, the reinforcement rib 30 is provided in the arm body excluding the attachment section 18 on the lower end except for a subtle range on the lower-end portion that has a narrow width dimension in the vehicle front-rear direction. This reinforcement rib 30 is one in which a center part of the pedal arm 14 in the vehicle front-rear direction is expanded to the same side as the front side flange 20 and the rear side flange 22, and is provided upon a bulging process by press working. The reinforcement rib 30 is, as with the pedal arm 14, made gradually narrow in width dimension as the reinforcement rib 30 extends from the upper-end portion in which the boss section 12 is provided towards the lower-end portion in which the tread section 16 is provided, and a transverse plane at right angles to the longitudinal direction is shaped of a trapezoid (upper wide side) to a reverse-U shape (lower narrow side), and relative front side recess 32 and rear side recess 34 are formed between the front side flange 20 and the rear side flange 22, respectively. Moreover, in a flat section 36 that constitutes the top part of the reinforcement rib 30 (top-bottom of the trapezoidal shape), the boss section 12 is provided substantially perpendicular thereto. The boss section 12 is provided integrally to the pedal arm 14 in a manner protruding from the flat section 36 in a direction opposite the expanding direction of the reinforcement rib 30, that is to say the right direction in FIG. 2, by carrying out a burring process to the flat section 36 by press working.

The upper-end portion of the reinforcement rib 30 is of a semi-circular shape whose center is the support shaft line S, and on a side closer to the periphery than the reinforcement rib 30, that is to say, a part between the reinforcement rib 30 and outer edge portions on which the hook section 24 and cable coupling section 26 are provided, an arc-shaped rib 40 is formed in a circumferential direction whose center is the support shaft line S. This arc-shaped rib 40 is provided by a bulging formation process by press working as with the reinforcement rib 30, and expands in a direction identical to the expanding direction of the reinforcement rib 30. By providing the arc-shaped rib 40, an arc-shaped recess 42 is formed between the arc-shaped rib 40 and the reinforcement rib 30, and the front side recess 32 and rear side recess 34 are connected to each other via the arc-shaped recess 42.

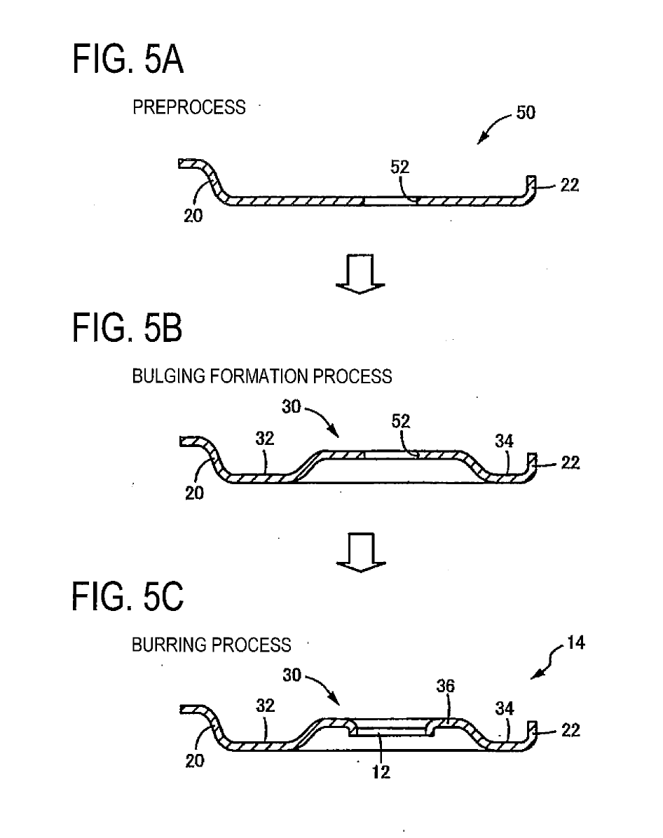

FIG. 5 is a view explaining one example of a manufacturing step of the pedal arm 14, and is a sectional view corresponding to FIG. 2. In a preprocessing step of (a), the metal plate material 50 is subjected to a bending processing and like process by press working, to form the front side flange 20 and rear side flange 22. In this preprocessing step also, a prepared hole 52 for forming the boss section 12 by a burring process is provided by for example press working. In a subsequent bulging formation processing step of (b), the reinforcement rib 30 and arc-shaped rib 40 are provided by bulging formation by press working, and simultaneously, the front side recess 32, the rear side recess 34, and the arc-shaped recess 42 are relatively formed. Thereafter, in a burring process step of (c), the burring process is carried out by press working to a part in which the prepared hole 52 of the flat section 36 in the reinforcement rib 30 is provided, to form the hollow cylindrically-shaped boss section 12 by making an opening of the prepared hole 52 stand up in a brim shape. As a result, the objective pedal arm 14 is obtained. The bending process of the front side flange 20 and rear side flange 22 in the preprocessing step of (a) may be carried out simultaneously to the bulging formation process of the reinforcement rib 30 and arc-shaped rib 40 in (b), and the prepared hole 52 may be provided after the bulging formation process of (b).

As such, in the parking brake pedal 10 of the present Example, the reinforcement rib 30 of the pedal arm 14 is formed continuously extending from the surroundings of the boss section 12 towards the lower-end portion of the pedal arm 14, and the boss section 12 is provided substantially perpendicular to the flat section 36 of the reinforcement rib 30; this improves the strength of the pedal arm 14 as appropriate including the surroundings of the boss section 12 to which a large load is applied at the time of the depressing operation, and allows for achieving further weight and cost reduction by thickness reduction while securing a required strength. In particular, the present example provides the reinforcement rib 30 to a substantially entire range from the surroundings of the boss section 12 to the lower-end portion, and thus can improve the strength of the entire pedal arm 14 as appropriate.

Moreover, although the pedal arm 14 is of a flat plate shape, providing the front side flange 20 and the rear side flange 22 allows for forming the front side recess 32 between the front side flange 20 and the reinforcement rib 30 and the rear side recess 34 between the rear side flange 22 and the reinforcement rib 30. Accordingly, it is possible even with the simple flat-plate-shaped pedal arm 14 to secure the required strength while attempting to reduce its thickness.

Moreover, an arc-shaped rib 40 is provided separately to the reinforcement rib 30 in the upper end portion of the pedal arm 14. Therefore, the rigidity around the support shaft line S is improved, which thus allows for securing a sufficient amount of the required strength even in the parking brake pedal 10 on which a relatively large depressing operation force is applied.

Moreover, the pedal arm 14 is made up of one piece of metal plate material 50, the reinforcement rib 30 is formed upon a bulging formation process by press working, and the boss section 12 is formed integrally to the pedal arm 14 by being subjected to a burring process by press working. Accordingly, it is possible to continuously mold these reinforcement rib 30 and boss section 12 in one series of press working processes, thereby reducing the manufacturing costs.

Moreover, since the boss section 12 is provided by the buffing process so as to protrude from the flat section 36 in just the direction opposite to the expanding direction of the reinforcement rib 30, it is possible to make the dimension in the vehicle width direction, that is to say, the dimension in the left-right direction in FIG. 2, compact.

Although an Example of the present application is described in details above based on the drawings, this is merely one embodiment, and the present application can be implemented in an aspect including various changes and modifications, based on the knowledge of a person skilled in the art.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

In order to attain the above object, a first aspect of the embodiment is characterized in that an operation pedal for vehicles comprises a plate-shaped pedal arm supported pivotally about a substantially horizontal support shaft line via a cylindrically-shaped boss section, the pedal arm includes a reinforcement rib provided expanding in a plate thickness direction and a tread section provided in a lower-end portion of the pedal arm to be depressing operated by a driver, wherein (a) the reinforcement rib is provided including surroundings of the boss section and extending continuously from the surroundings of the boss section towards the lower-end portion of the pedal arm, and (b) the boss section is provided perpendicularly to a flat section constituting a top part of the reinforcement rib.

A second aspect of the embodiment is characterized in that, in the operation pedal for vehicles of the first aspect of the embodiment, the pedal arm includes an arc-shaped rib provided in an upper-end portion of the pedal arm on an outer side of the reinforcement rib with regard to a circumference of the support shaft line serve as pivot center, the arc-shaped rib expanding in a direction identical to the expanding direction of the reinforcement rib.

A third aspect of the embodiment is characterized in that an operation pedal for vehicles comprises a plate-shaped pedal arm supported pivotally about a substantially horizontal support shaft line via a cylindrically-shaped boss section, the pedal arm includes a reinforcement rib provided expanding in a plate thickness direction and a tread section provided in a lower-end portion of the pedal arm to be depressing operated by a driver, wherein (a) the reinforcement rib is provided including surroundings of the boss section and extending continuously from the surroundings of the boss section towards the lower-end portion of the pedal arm, and (b) the boss section is provided perpendicularly to a fiat section constituting a top part of the reinforcement rib.

And the pedal arm includes an arc-shaped rib provided in an upper-end portion of the pedal arm on an outer side of the reinforcement rib with regard to a circumference of the support shaft line serve as pivot center, the arc-shaped rib expanding in a direction identical to the expanding direction of the reinforcement rib.

A fourth aspect of the embodiment is characterized in that, in the operation pedal for vehicles of any one of the first aspect to the third aspect of the embodiment, (a) the pedal arm is made up of a metal plate material, (b) the reinforcement rib is formed upon bulging by press working, and (c) the boss section is provided integrally to the pedal arm by being subjected to a burring process by press working.

A fifth aspect of the embodiment is characterized in that, in the operation pedal for vehicles of any one of the first aspect to the fourth aspect of the embodiment, the boss section is provided protruding out from the flat section in just a direction opposite to the expanding direction of the reinforcement rib.

In such an operation pedal for vehicles, the reinforcement rib is provided continuously extending towards the lower-end portion from the surroundings of the boss section, and the boss section is provided perpendicularly to a flat section constituting the top part of the reinforcement rib. This enhances the strength of the pedal arm as appropriate including the surroundings of the boss section on which a large load is applied at the time of the depressing operation, and thus allows for further reduction in weight and cost by thickness reduction while securing a required strength.

And a case in which the pedal arm is of a flat plate shape having a front side flange and a rear side flange provided thereto, which thus forms a recess between the front side flange and the reinforcement rib and between the rear side flange and the reinforcement rib. Accordingly, it is possible to secure a required strength while carrying out thickness reduction, even with a simple flat-plate-shaped pedal arm.

In the second aspect and the third aspect of the embodiment, an arc-shaped rib is provided separately to the reinforcement rib on the upper-end portion of the pedal arm. This thus enhances the rigidity around the support shaft line, thus making it possible to sufficiently secure a required strength even with a parking brake pedal and service brake pedal on which a relatively large depressing operation force is applied.

The fourth aspect is of a case in which the pedal arm is made up of a metal plate material, the reinforcement rib is formed upon bulging by press working, and the boss section is formed integrally to the pedal arm by being subjected to a burring process by press working. Accordingly, it is possible to mold the reinforcement rib and boss section in a series of press working processes, thus reducing manufacturing costs thereof.

In the fifth aspect, the boss section is provided so as to protrude from the flat section in just a direction opposite to the expanding direction of the reinforcement rib. Accordingly, it is possible to configure a dimension in the vehicle width direction in a compact manner.

1. An operation pedal for vehicles, comprising a plate-shaped pedal arm supported pivotally about a substantially horizontal support shaft line via a cylindrically-shaped boss section, the pedal arm includes a reinforcement rib provided expanding in a plate thickness direction and a tread section provided in a lower-end portion of the pedal arm to be depressing operated by a driver, wherein
the reinforcement rib is provided including surroundings of the boss section and extending continuously from the surroundings of the boss section towards the lower-end portion of the pedal arm,
the boss section is provided perpendicularly to a flat section constituting a top part of the reinforcement rib, and
the pedal arm is of a flat plate shape, that includes a front side flange provided on an outer peripheral edge portion of a front side of the vehicle and a rear side flange provided on an outer peripheral edge portion of a rear side of the vehicle, the front side flange and rear side flange each protruding in identical directions to an expanding direction of the reinforcement rib, and the pedal arm includes a recess formed between the front side flange and the reinforcement rib and between the rear side flange and the reinforcement rib.

2. The operation pedal for vehicles according to claim 1, wherein
the pedal arm includes an arc-shaped rib provided in an upper-end portion of the pedal arm on an outer side of the reinforcement rib with regard to a circumference of the support shaft line serve as pivot center, the arc-shaped rib expanding in a direction identical to the expanding direction of the reinforcement rib.

3. An operation pedal for vehicles, comprising a plate-shaped pedal arm supported pivotally about a substantially horizontal support shaft line via a cylindrically-shaped boss section, the pedal arm includes a reinforcement rib provided expanding in a plate thickness direction and a tread section provided in a lower-end portion of the pedal arm to be depressing operated by a driver, wherein
the reinforcement rib is provided including surroundings of the boss section and extending continuously from the surroundings of the boss section towards the lower-end portion of the pedal arm,
the boss section is provided perpendicularly to a flat section constituting a top part of the reinforcement rib, and
the pedal arm includes an arc-shaped rib provided in an upper-end portion of the pedal arm on an outer side of the reinforcement rib with regard to a circumference of the support shaft line serve as pivot center, the arc-shaped rib expanding in a direction identical to the expanding direction of the reinforcement rib.

4. The operation pedal for vehicles according to claim 1, wherein
the pedal arm is made up of a metal plate material,
the reinforcement rib is formed upon bulging by press working, and
the boss section is provided integrally to the pedal arm by being subjected to a burring process by press working.

5. The operation pedal for vehicles according to claim 1, wherein
the boss section is provided protruding out from the flat section in just a direction opposite to the expanding direction of the reinforcement rib.
